(19) United States
(12) Patent Application Publication
(10) Pub. No.: US 2026/0200705 A1
(43) Pub. Date: Jul. 16, 2026

(54) Upending Device

(71) Applicant: IQIP Holding B.V., Sliedrecht (NL)

(72) Inventors: Quinten ZUIJDGEEST, Sliedrecht (NL); Marius PEERDEMAN, Sliedrecht (NL)

(73) Assignee: IQIP Holding B.V., Sliedrecht (NL)

(21) Appl. No.: 19/133,022

(22) PCT Filed: Nov. 22, 2023
(86) PCT No.: PCT/NL2023/050612

§ 371 Date: May 27, 2025

(30) Foreign Application Priority Data
Nov. 28, 2022 (NL) 2033633

(51) Int. Cl. B66C 1/56; B66C 13/08; E02D 13/00

(52) U.S. Cl. CPC B66C 1/56; B66C 13/085; E02D 13/00

(57) ABSTRACT

Upending device (1) for upending tubular piles (FP, CP), the upending device comprising; a base element (20) for insertion into an end of, and for extending along an inside of, the tubular pile; a plurality of connection elements connected to the base element and configured to engage with one or more inside surfaces of the tubular pile; and a lifting arm (30) for coupling the upending device to a hoisting element (H); wherein the lifting arm is rotatably coupled to the base element, the lifting arm being rotatable relative to the base element about a first axis (A1), wherein the first axis is a central axis of the base element and is substantially parallel to a central axis of the tubular pile, in use. The invention further relates to a method of upending a tubular pile, using the device.

This invention relates generally to an upending device and a method of upending a tubular pile. Due to their length, tubular piles, such as monopiles, are usually transported in a horizontal orientation. This means that, upon deployment into a vertical orientation, the tubular piles must be upended. Clearly, due to the size and weight of the tubular piles, such an operation is complex, time consuming, and expensive in terms of the capital cost of equipment and the operating time. Known types of tubular piles are conical, un-flanged piles, which have an open end without a flange, and flanged piles, which have an inwardly projecting flange at one end. The process of upending flanged piles usually includes inserting an upending tool into the flanged end of the pile and engaging a connection element of the upending tool with the flange such that the tubular pile is effectively lifted by gripping the flange. Upending un-flanged piles typically includes inserting an upending tool into the narrowest end of the pile and using radially extending connection elements which grip the inside radial surface of the pile in a frictional manner. Clearly, both of these upending tools are large, complicated to operated, and expensive to purchase, to transport, and to maintain.

Furthermore, both of these types of upending tool apply significant pressure and bending forces at the locations where the connection elements engage with the pile. This can cause damage to the pile, for example if the engagement is at a defect or a weaker part of the structure, for example at a weld location such as the seam of the pile.

Sometimes these upending tools are used to deploy the pile to the ground into which the pile will be driven. This means that the engagement between the pile and the upending device, which is achieved at the start of the upending operation, is also used during deployment of the pile to the ground. Clearly this has the potential to be suboptimal because the upending tool is inserted into the pile while the pile is horizontal, and so aligning the upending tool with the tubular pile can be challenging, for example because the upending tool is not centrally aligned with the pile. It would therefore be advantageous to overcome at least some of these limitations.

Accordingly, a first aspect of the invention provides an upending device for upending tubular piles, the upending device comprising;
a base element for insertion into an end of, and for extending along an inside of, the tubular pile;
a plurality of connection elements connected to the base element and configured to engage with one or more inside surfaces of the tubular pile;
a lifting arm for coupling the upending device to a hoisting element;
wherein the lifting arm is rotatably coupled to the base element, the lifting arm being rotatable relative to the base element about a first axis, wherein the first axis is a central axis of the base element and is substantially parallel to a central axis of the tubular pile, in use.

Advantageously, the base element and connection elements may be rotated, about the first axis, to avoid engagement between the connection elements being at, or at least to reduce the risk that engagement between the connection elements is at, suboptimal locations, such as at weld locations, in the pile. Further advantageously, the base element and connection elements may be rotatable about the first axis, when inserted into the tubular pile, to vertically align two of the connection elements. This may aid in centralising the upending device in the pile, because engagement of the vertically aligned connection elements can be used to align the upending device in the vertical direction. Furthermore, these vertically aligned connection elements can be engaged with the tubular pile first, to further aid in centralising the upending device in the tubular pile. Further advantageously, the heading of the pile is alterable during deployment, by rotating the base element and the connection elements about the first axis. Thereby, the heading of the pile can be fine-tuned. This may be advantageous in controlling the heading of the pile as it is lowered to the ground into which it will be driven. This may also be advantageous when the pile is connected to an upper part e.g. a tower or transition piece, which are connected together e.g. bolted or use a wedge connection, along the length thereof, such that a first lower part of the pile is supported on a surface in an upright configuration, and a second upper part is lowered onto the first lower part such that they can be bolted together. Rotating the second upper part about the first axis means that the connection holes in the first and second parts, e.g. of the pile, can be easily aligned for connecting the two parts together.

Each of the plurality of connection elements may be movable in a radial direction. Each of the plurality of connection elements may be movable to a radially retracted position. Advantageously, the base element and connection elements are insertable into an end of the pile which has a smaller internal diameter than the diameter at the location where the connection elements engage the pile, by inserting the base element while the connection elements are in a radially retracted position. Further advantageously, this means that the upending device is suitable for use with flanged piles and conical, un-flanged piles. That is, this means that the upending device is suitable for insertion into a flanged end of a flanged pile, and for insertion into a narrowest end of a conical, un-flanged pile.

The upending device may comprise a mounting element. The lifting arm may be rotatably coupled to the base element via the mounting element. The mounting element may be rotatably coupled to the base element. The mounting element may be rotatable relative to the base element about the first axis.

The lifting arm may be rotatable relative to the base element about a second axis. The second axis may be substantially perpendicular to the first axis.

Advantageously, the base element and connection elements may be rotated about the second axis, relative to the lifting arm, such that the upending device is supported by the hoisting element for insertion of the base element and connection elements inserted into the end of the pile while the pile is horizontal.

The lifting arm may be rotatably coupled to the mounting element. The lifting arm may be rotatable relative to the mounting element about the second axis.

The base element may comprise at least two interconnected, concentric rings. The mounting element may extend through the centre of an inner ring of the concentric rings. The mounting element may rotatably coupled to the inner ring of the concentric rings. The mounting element may be supported in the axial direction of the inner ring by an axial bearing. The mounting element may be supported in the radial direction of the inner ring by at least two radial bearings. The at least two concentric rings may be interconnected by webs.

The base element may comprise three interconnected, concentric rings. The plurality of connection elements may be connected to an outer ring of the concentric rings and an intermediate ring of the concentric rings. The mounting element may extend through the centre of an inner ring of the concentric rings. The mounting element may be supported in the axial direction of the inner ring by an axial bearing. The mounting element may be supported in the radial direction of the inner ring by at least two radial bearings. The mounting element may be rotatably coupled to the inner ring of the concentric rings. The outer ring and the intermediate ring of the concentric rings may be interconnected by a plurality of outer webs. The intermediate ring and the inner ring of the concentric rings may be interconnected by a plurality of inner webs.

Advantageously, the provision of a base element with concentric rings may improve operability, because the base element is able to have a high degree of axial symmetry, thereby allowing the base element and connection elements to be usable in a number of orientations about the first axis. Furthermore, this may mean that the base element is substantially balanced, when the central axis thereof is in the vertical orientation, about the central axis. This may reduce the power input required to rotate the base element about the first axis, even when a pile is suspended from the upending device. Further advantageously, the connection between the connection element and both of the inner and outer rings may improve the stability of the upending device during an upending operation, because each connection element is about to withstanding bending moments from the pile, by the connection to both the inner and outer rings.

The upending device may comprise a lifting arm driving device. The lifting arm driving device may be for rotation of the lifting arm about the second axis. The lifting arm driving device may be for rotation of the lifting arm about the second axis, relative to the base element.

The lifting arm driving device may be a linear actuator. The linear actuator may be pivotally connected, at a first end, to the lifting arm. The linear actuator may be pivotally connected, at a first end, to the lifting arm at a position spaced from the second axis. The linear actuator may be pivotally connected, at a second end, to the mounting element. The linear actuator may be pivotally connected, at a second end, to the mounting element at a position spaced from the first axis.

Advantageously, the base element and connection elements may be rotated about the second axis for insertion into the pile, while the pile is horizontal.

The upending device may comprise driving means located between the mounting element and the base element. The driving means may be for controlling rotational movement, about the first axis, of the base element relative to the mounting element.

The driving means may comprise a pinion and a gear rack. The pinion may be rotatably mounted to the mounting element. There may be at least two pinions rotatably mounted to the mounting element. There may be three pinions rotatably mounted to the mounting element where one of the pinions is an emergency, or backup, or dummy gear. The gear rack may be provided on or in the base element. The upending device may comprise pinion rotation means, such as an electric motor, for rotating the pinion. The upending device may comprise a plurality of pinion rotation means, such as electric motors, each pinion rotating means for rotating a respective one of the pinion. Advantageously, these driving means allows fine motion control, or fine positional control, of the rotation of the base element relative to the mounting element.

Each connection element may comprise an engagement part. The engagement part may comprise a coupling portion. The coupling portion may have a coupling surface facing radially inwardly. Each connection element may comprise a connection part. The connection part may comprise a radially outer portion. The radially outer portion may have a coupling surface facing radially outwardly. The connection part may be movable. The connection part may be movable in the radial direction relative to the tubular pile in use, between a radially outer position and a radially inner position. The connection part may be movable in the radial direction relative to the tubular pile in use, between a radially outer position and a radially inner position, to bring the coupling surface of the engagement part into abutment with the coupling surface of the radially outer portion of the connection part. The coupling surface of the engagement part may abut the coupling surface of the radially outer portion of the connection part. Each connection part and corresponding engagement part, i.e. each connection element, may be movable in the radial direction. The connection part may comprise first connection means at the radially outer end of each connection part. The first connection means may be for connection to axial locking means. The axial locking means may be for connection between the connection part and the engagement part. The axial locking means may be for connection between the connection part and the engagement part for restricting axial movement of the engagement part relative to the connection part. The base element may comprise second connection means. The base element may comprise second connection means for connection to actuation means connectable between the base element and the engagement part, for moving the engagement part along the coupling surface of the connection part.

Advantageously, the same upending device is usable with both a flanged pile and an un-flanged pile. That is, the provision of first and second connection means in the manner described allows an engagement part to be connected to the radially outer end of each connection part using axial locking means when the upending device is to be used with a flanged pile, and allows actuation means to be connected between each engagement part and the second connection means on the base element when the upended device is to be used with an un-flanged, conical pile. As a result, a more versatile upending device is provided.

The coupling portion of the engagement part may be a tapered portion. The radial thickness of the tapered portion may be tapered. The radial thickness of the tapered portion may be tapered away from the side of the base element on which the lifting arm is located. The radial thickness of the radially outer portion of the connection part may be tapered. The radial thickness of the radially outer portion may be tapered towards the side of the base element on which the lifting arm is located.

Each connection element may comprise two, parallel, connection parts. Each engagement part may comprise two, parallel, coupling portions Each engagement part may comprise two, parallel, tapered portions. The radial thickness of the tapered portions may be tapered. The radial thickness of the tapered portions may be tapered away from the side of the base element on which the lifting arm is located. The coupling portions or the tapered portions may each have a coupling surface facing radially inwardly. Each coupling surface of the engagement part may abut the coupling surface of the radially outer portion of a respective one of the connection parts of the connection element. Each coupling surface of the engagement part may abut the coupling surface of the radially outer portion of a respective one of the connection parts of the connection element when the connection part is in the radially outer position. Each connection element may comprise a driving plate connected to a radially inner end of the or each connection part. Each connection element may comprise a drive shaft. Each drive shaft may pass through an aperture in the respective driving plate. Each drive shaft may comprise a flange, or enlarged head, at one end, which is attached or is attachable to the driving plate. Each drive shaft may be engaged with the base element such that rotation of the drive shaft moves the driving plate in a radial direction. Each drive shaft may comprise an external thread, for example a trapezoidal thread. Each connection element may comprise a gear nut. Each gear nut may comprise an external gear, for example a spur gear or a helical gear. Each gear nut may comprise an internal thread, for example a trapezoidal thread. Each connection element may comprise a driving pinion. Each driving pinion may comprise a driving pinion drive means, for example an hydraulic drive. Each driving pinion may be engaged with the external gear of the gear nut. The internal thread of each gear nut may be engaged with the external thread of the respective drive shaft. Each gear nut may be axially fixed to the base element, for example to the driving web. Rotation of each pinion may rotate the respective gear nut which drives the respective drive shaft in a radial direction relative to the base element.

The base element may comprise at least two interconnected, concentric rings. Each ring may comprise a plurality of apertures therethrough. Each aperture may correspond to a connection element. Each aperture in an outer ring of the concentric rings may be aligned with a corresponding aperture in an inner ring of the concentric rings. The connection part of each connection element may extend through an aperture in each ring. The connection part of each connection element may extend through an aperture in each ring in both the radially outer and radially inner position. The apertures may provide a guide. The apertures may provide a guide for the guiding movement of the respective connection part. The two apertures may provide a guide for the guiding movement of the respective connection part between the radially outer position and the radially inner position.

Advantageously, each connection part may be supported in bending by the apertures in the outer and intermediate rings.

The at least two interconnected, concentric rings may comprise three interconnected, concentric rings. The apertures may be comprised in the outer ring and an intermediate ring of the three concentric rings. The lifting arm may be rotatably connected to an inner ring of the three concentric rings.

The at least one connection part may comprise two, parallel, connection parts. Each engagement part may comprise first and second coupling surfaces. The coupling surfaces of an engagement part may each abut a coupling surface of the radially outer end of a corresponding connection part.

The upending device may comprise a drive shaft located between a radially inner end of each connection part and the base element. Each drive shaft may be configured to translate the respective connection part in the radial direction.

The upending device may comprise at least one guiding element. The upending device may comprise at least one guiding element attached to the base element. The upending device may comprise at least one guiding element attached to the base element for contacting a radially inner surface of the tubular pile to control the radial position of the base element with respect to the tubular pile, in use.

The at least one guiding element may comprise at least two centralisers. Each centraliser may be radially slidably connected to the base element. Each centraliser may be located on a respective radial half of the base element. Each centraliser may be extendable from a radially outer surface of the base element. The upending device may comprise centraliser driving means for driving the centralisers.

In embodiments, the upending device comprises a hoisting element controller rotatably connected to the lifting arm about a third axis. The third axis may be parallel to the second axis. The third axis may be perpendicular to the first axis The hoisting element controller may comprise first and second connecting elements connecting spaced apart plates of the hoisting element controller together. The first and second connecting element may be elements of circular cross-section, such as tubes or robs, connected at either end to respective spaced apart plate. An opening may be defined by the connecting elements and the spaced apart plates of the hoisting element controller, such that, in use, the hoisting element can pass, or extend, through the opening.

The hoisting element controller may be rotated about the second shaft between a first position and a second position. In the first position, the opening of the hoisting element controller may be perpendicular, for example a plane of the opening may be perpendicular, to a central axis of the lifting arm, for example to an axis, or line, extending between the third axis and the second axis. In the second position, the opening may be at an oblique angle, for example a plane of the opening may be at an oblique angle to, the central axis of the lifting arm, for example to the axis, or line, extending between the third axis and the second axis.

Advantageously, the lifting line applied by the hoisting element may be offset from a centreline of the base element by rotating the hoisting element about the third axis, due to one of the connecting elements intersecting a lifting line from the lifting point of the lifting arm.

The hoisting element controller may comprise securing means for securing, i.e., to prevent relative rotating movement about the third axis, the hoisting element controller to the lifting arm in the second position. The securing means may secure the hoisting element controller in the second position. Advantageously, when the hoisting element controller is secure din the second position the lifting line of the hoisting element may be more closely aligned, or may be aligned, with a centreline of the base element while the base element is orientated with the centreline parallel to a centreline of a pile which is lying on a deck.

According to a further aspect of the invention there is provided an upending device for upending tubular piles, the upending device comprising:
a base element for insertion into an end of, and for extending along an inside of, the tubular pile;
a plurality of connection elements connected to the base element and configured to engage with one or more inside surfaces of the tubular pile;
a lifting arm for coupling the upending device to a hoisting element, the lifting arm rotatably coupled to the base element about a lifting arm axis;
a hoisting element controller rotatably connected to the lifting arm about a hoisting element controller axis, the hoisting element controller axis being parallel to the lifting arm axis.

The hoisting element controller may be the aforementioned hoisting element controller. The lifting arm axis may be the aforementioned second axis. The hoisting element controller axis may be the aforementioned third axis.

According to a further aspect of the invention there is provided a method of upending a tubular pile, the method comprising the following steps:
a) inserting a base element into a first end of the tubular pile;
b) rotating the base element about a first axis, the first axis being a central axis of the base element and being substantially parallel to a central axis of the tubular pile, to a desired orientation with respect to the tubular element;
c) radially outwardly moving an engagement part of each of a plurality of connection elements to engage with one or more inside surfaces of the tubular pile;
d) lifting the first end of the tubular pile by hoisting a lifting arm, using a hoisting element connected to the lifting arm, the lifting arm being connected to the base element.

The method may further comprise step a1), wherein step a1) precedes step a). Step a1) may comprise lowering the base element, the plurality of connection elements and the lifting arm into a position adjacent the first end of the tubular pile. Step a1) may comprise rotating the base element and the plurality of connection elements relative to the lifting arm about a second axis. The second axis may be perpendicular to the first axis. Rotating the base element and the plurality of connection elements relative to the lifting arm about a second axis may substantially align the first axis and the central axis of the tubular pile.

Step d) may comprise rotating the lifting arm, relative to the base element and the plurality of connection elements, about the or a second axis. The second axis may be perpendicular to the first axis. Step d) may comprise rotating the lifting arm, relative to the base element and the plurality of connection elements, about the or a second axis while the first end of the tubular pile is suspended by the upending device.

According to a further aspect of the invention there is provided a method of deploying a tubular pile, the method comprising the aforementioned method of upending the tubular pile, the method comprising the subsequent step of rotating the base element, the plurality of connection elements and the tubular pile about the first axis to adjust the heading of the tubular pile. According to a further aspect of the invention there is provided an upending device for upending tubular piles, the upending device comprising:
a base element for insertion into an end of, and for extending along an inside of, the tubular pile;
a lifting arm connected to the base element, the lifting element being for coupling the upending device to a hoisting element;
a plurality of connection elements connected to the base element and configured to engage with one or more inside surfaces of the tubular pile, wherein each connection element comprises:

an engagement part, the engagement part comprising a coupling portion, wherein the coupling portion has a coupling surface facing radially inwardly; and
a connection part, the connection part comprising:

a radially outer portion, wherein the coupling surface of the engagement part abuts the coupling surface of the radially outer portion of the connection part, and wherein each connection part and corresponding engagement part are moveable in the radial direction; and first connection means at the radially outer end of each connection part, the first connection means for connection to axial locking means, the axial locking means being for connection between the connection part and the engagement part, for restricting axial movement of the engagement part relative to the connection part, and wherein the base element comprises second connection means for connection to actuation means connectable between the base element and the engagement part, for moving the engagement part along the coupling surface of the connection part.

Advantageously, the same upending device is usable with both a flanged pile and an un-flanged pile. That is, the provision of first and second connection means in the manner described allows an engagement part to be connected to the radially outer end of each connection part using axial locking means when the upending device is to be used with a flanged pile, and allows actuation means to be connected between each engagement part and the second connection means on the base element when the upended device is to be used with an un-flanged, conical pile. As a result, a more versatile upending device is provided.

Further advantageously, radial movement of the connection part and the engagement part allows upending device to be insertable into an end of the pile which has a smaller internal diameter than the diameter at the location where the connection elements engage the pile. That is, the base element when be inserted into an end of the pile while the connection elements are in a radially retracted position. Again, this means that the upending device is suitable for use with flanged piles and conical, un-flanged piles. This reduces the complexity of operation, as operation of the upending device is similar in both configurations. This also reduces expenditure as only one upending device needs to be obtained and maintained. This also reduces the amount of space required, for example on an offshore vessel, for upending devices.

The coupling portion of the engagement part may be a tapered portion. The radial thickness of the tapered portion may be tapered. The radial thickness of the tapered portion may be tapered away from the side of the base element on which the lifting arm is located. The radial thickness of the radially outer portion of the connection part may be tapered. The radial thickness of the radially outer portion may be tapered towards the side of the base element on which the lifting arm is located.

Each connection element may comprise two, parallel, connection parts. Each engagement part may comprise two, parallel, coupling or tapered portions. The radial thickness of the tapered portions may be tapered. The radial thickness of the tapered portions may be tapered away from the side of the base element on which the lifting arm is located. The coupling or tapered portions may each have a coupling surface facing radially inwardly. Each coupling surface of the engagement part may abut the coupling surface of the radially outer portion of a respective on of the connection parts of the connection element. Each coupling surface of the engagement part may abut the coupling surface of the radially outer portion of a respective on of the connection parts of the connection element when the connection part is in the radially outer position. Each connection element may comprise a driving plate connected to a radially inner end of the or each connection part. Each connection element may comprise a drive shaft. Each drive shaft may pass through an aperture in the respective driving plate. Each drive shaft may comprise a flange, or enlarged head, at one end, which is attached or is attachable to the driving plate. Each drive shaft may be engaged with the base element such that rotation of the drive shaft moves the driving plate in a radial direction. Each drive shaft may comprise an external thread, for example a trapezoidal thread. Each connection element may comprise a gear nut. Each gear nut may comprise an external gear, for example a spur gear or a helical gear. Each gear nut may comprise an internal thread, for example a trapezoidal thread. Each connection element may comprise a driving pinion. Each driving pinion may comprise a driving pinion drive means, for example an hydraulic drive. Each driving pinion may be engaged with the external gear of the gear nut. The internal thread of each gear nut may be engaged with the external thread of the respective drive shaft. Each gear nut may be axially fixed to the base element, for example to the driving web. Rotation of each pinion may rotate the respective gear nut which drives the respective drive shaft in a radial direction relative to the base element.

The base element may comprise at least two interconnected, concentric rings. Each ring may comprise a plurality of apertures therethrough. Each aperture may correspond to a connection element. Each aperture in an outer ring of the concentric rings may be aligned with a corresponding aperture in an inner ring of the concentric rings. The connection part of each connection element may extend through an aperture in each ring. The connection part of each connection element may extend through an aperture in each ring in both the radially outer and radially inner position. The apertures may provide a guide. The apertures may provide a guide for the guiding movement of the respective connection part. The two apertures may provide a guide for the guiding movement of the respective connection part between the radially outer position and the radially inner position.

The at least two interconnected, concentric rings may comprise three interconnected, concentric rings. The apertures may be comprised in the outer ring and an intermediate ring of the three concentric rings. The lifting arm may be rotatably connected to an inner ring of the three concentric rings.

The at least one connection part may comprise two, parallel, connection parts. The at least one coupling surface of each engagement part may be two coupling surfaces of the engagement part. The at least one coupling surface of each engagement part may be two coupling surfaces of the engagement part which each abut a coupling surface of the radially outer end of a respective one of the corresponding connection parts.

The upending device may comprise an drive shaft. The drive shaft may be located between a radially inner end of each connection part and the base element. Each drive shaft may be configured to move the respective connection part in the radial direction.

The lifting arm may be rotatably coupled to the base element. The lifting arm may be rotatable relative to the base element about a first axis. The first axis may be a central axis of the base element. The first axis may be substantially parallel to a central axis of the tubular pile, in use. The upending device may comprise a mounting element. The lifting arm may be rotatably coupled to the base element via the mounting element. The mounting element may be rotatably coupled to the base element. The mounting element may be rotatable relative to the base element about the first axis.

The lifting arm may be also rotatable relative to the base element about a second axis. The second axis may be substantially perpendicular to the first axis.

The lifting arm may be rotatably coupled to the mounting element. The lifting arm may be rotatable relative to the mounting element about the second axis.

The base element may comprise at least two interconnected, concentric rings. The mounting element may extend through the centre of an inner ring of the concentric rings. The mounting element may be rotatably coupled to the inner ring of the concentric rings. The mounting element may be supported in the axial direction of the inner ring by an axial bearing. The mounting element may be supported in the radial direction of the inner ring by at least two radial bearings. The concentric rings may be interconnected by a plurality of webs.

The base element may comprise three interconnected, concentric rings. The plurality of connection elements may be connected to an outer ring and an intermediate ring of the concentric rings. The mounting element may extend through the centre of an inner ring of the concentric rings. The mounting element may be rotatably coupled to the inner ring of the concentric rings. The mounting element may be supported in the axial direction of the inner ring by an axial bearing.

The mounting element may be supported in the radial direction of the inner ring by at least two radial bearings. The outer ring and the intermediate ring of the concentric rings may be interconnected by a plurality of outer webs. The intermediate ring and the inner ring of the concentric rings may be interconnected by a plurality of inner webs.

The upending device may comprise a lifting arm driving device. The lifting arm driving device may be for rotation of the lifting arm. The lifting arm driving device may be for rotation of the lifting arm about the second axis, with respect to the base element.

The lifting arm driving device may be a linear actuator. The linear actuator may be pivotally connected, at a first end, to the lifting arm. The linear actuator may be pivotally connected, at a first end, to the lifting arm at a position spaced from the second axis. The linear actuator may be pivotally connected, at a second end, to the mounting element. The linear actuator may be pivotally connected, at a second end, to the mounting element at a position spaced from the first axis.

The pipe upending device may comprise driving means located between the mounting element and the base element. The driving means may be for controlling rotational movement, about the first axis, of the base element with respect to the lifting arm.

The driving means may comprise a pinion and a gear rack. The pinion may be rotatably mounted to the mounting element. The gear rack may be provided in or on the base element. There may be at least two pinions rotatably mounted to the mounting element. There may be three pinions rotatably mounted to the mounting element where one of the pinions is an emergency, or backup, or dummy gear. The upending device may comprise pinion rotation means, such as an electric motor, for rotating the pinion. The upending device may comprise a plurality of pinion rotation means, such as electric motors, each pinion rotating means for rotating a respective one of the pinion.

According to a further aspect of the invention there is provided an upending system, the upending system comprising:
the aforementioned upending device;
the axial locking means; and
the actuation means;
wherein each connection element has a frictional lifting configuration and a flange lifting configuration.

In the frictional lifting configuration, the engagement parts may be connected or connectable to the actuation means when the actuation means are connected to the connection means of the base element. In the flange lifting configuration, the engagement parts may be connected or connectable to the axial locking means when the axial locking means are connected to the respective at least one connection part.

Each connection element may comprise the or an engagement part. Each connection element may comprise at least one strip of teeth. The at least one strip of teeth may be attachable to a radially outer surface of the respective engagement part. In the frictional lifting configuration the at least one strip of teeth is attached to each engagement part. Each connection element may comprise at least one radial rail. The at least one radial rail may be attached or attachable to the radially outer surface of the respective engagement part. The connection element may comprise at least one axial rail. The at least one axial rail may be attached or attachable to an axial surface of the respective engagement part. The at least one axial rail may be attachable to the axial surface of the respective engagement part proximal the radially outer surface of the respective engagement part. The axial surface may face the lifting arm, in use. In the flange lifting configuration the at least one axial rail may be attached to each engagement part. In the flange lifting configuration at least one radial rail may be attached to each engagement part.

In the frictional lifting configuration the axial rails may be detached from each engagement part. In the flange lifting configuration the strip of teeth may be detached from each engagement part. In the frictional lifting configuration the strips of teeth may be configured to engage with an inside radial surface of the pile. In the flange lifting configuration the radial rails may be configured to abut, or be proximal to, an inside radial surface of the pile, and the axial rails may be configured to abut an inside axial surface of a flange of the pile.

Advantageously, the engagement parts can be interchanged or reconfigured for use with a flanged pile or with an un-flanged pile. For example, the strips of teeth and the axial and radial rails may be interchangeable on a given engagement part such that the upending device can be easily and quickly changed for use with a flanged pile or with an un-flanged pile.

The plurality of engagement parts may comprise frictional engagement parts, the frictional engagement parts being connectable to the actuation means when the actuation means are connected to the connection means of the base element. Each frictional engagement part may comprise at least one strip of teeth.

The plurality of engagement parts may comprise flange engagement parts, the flange engagement parts being connectable to the axial locking means when the axial locking means are connected to the respective at least one connection part. Each flange engagement part may comprise at least one axial rail. Each flange engagement part may comprise at least one radial rail.

According to a further aspect of the invention there is provided a method of upending a tubular pile using the aforementioned upending system, the method comprising the following steps:
a) connecting each one of the plurality of engagement parts to a respective one or more connection part to form the respective connection element;
b) inserting the base element into a first end of the tubular pile;
c) radially outwardly moving the plurality of connection elements to engage with one or more inside surfaces of the tubular pile;
d) lifting the first end of the tubular pile by hoisting a lifting arm, using a hoisting element connected to the lifting arm, the lifting arm being connected to the base element.

Step a) may comprise configuring the connection elements into either the frictional lifting configuration or the flange lifting configuration. Configuring the connection elements into the frictional lifting configuration may comprise detaching any radial and/or axial rails which are attached to engagement parts. Configuring the connection elements into the frictional lifting configuration may comprise attaching at least one strip of teeth to each engagement part. Configuring the connection elements into the flange lifting configuration may comprise detaching any strips of teeth which are attached to engagement parts. Configuring the connection elements into the flange lifting configuration may comprise attaching at least one axial rail to each engagement part.

For the avoidance of doubt, any of the features described herein apply equally to any aspect of the invention. For example, the upending device of the first aspect may comprise any one or more features of the upending device of the further aspects and/or the methods may comprise any one or more features or steps relevant to one or more features of the upending device of the further aspects.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. For the avoidance of doubt, the terms “may”, “and/or”, “e.g.”, “for example” and any similar term as used herein should be interpreted as non-limiting such that any feature so-described need not be present. Indeed, any combination of optional features is expressly envisaged without departing from the scope of the invention, whether or not these are expressly claimed. The applicant reserves the right to change any originally filed claim or file any new claim accordingly, including the right to amend any originally filed claim to depend from and/or incorporate any feature of any other claim although not originally claimed in that manner.

Embodiments of the invention will now be described by way of example only with reference to the accompanying drawings in which:

FIG. 1 is an isometric view of an upending device according to the invention, the upending tool being in a frictional lifting mode;

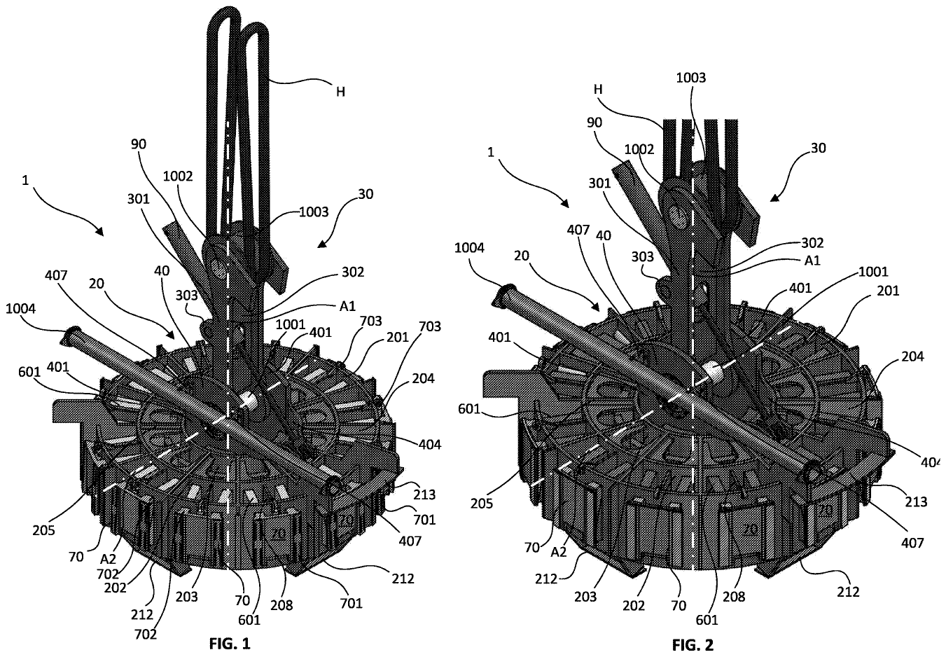

FIG. 2 is an isometric view of the upending device of FIG. 1, in a flange lifting mode;

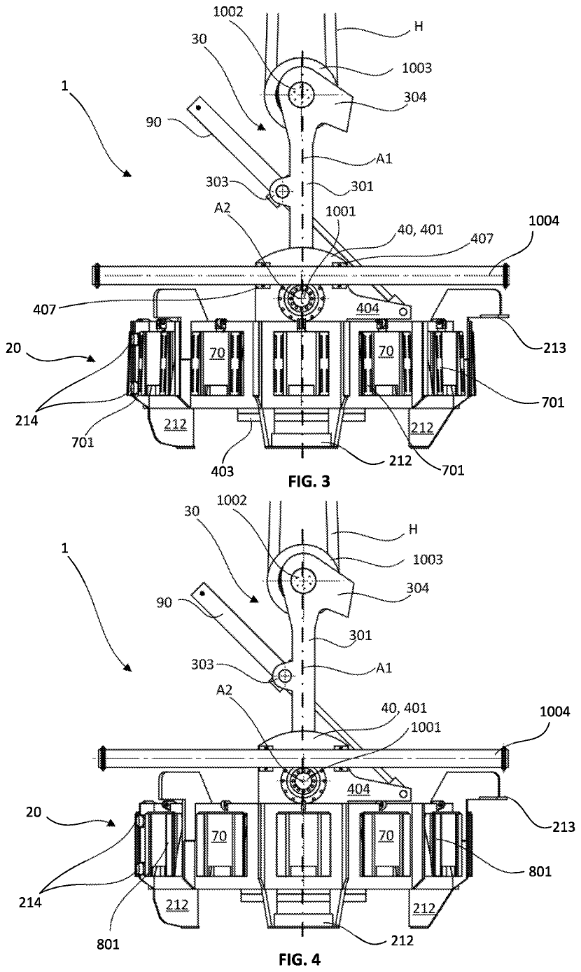

FIG. 3 is side view of the upending device of FIG. 1, in the frictional lifting mode;

FIG. 4 is a side view of the upending device of FIG. 1, in the flange lifting mode;

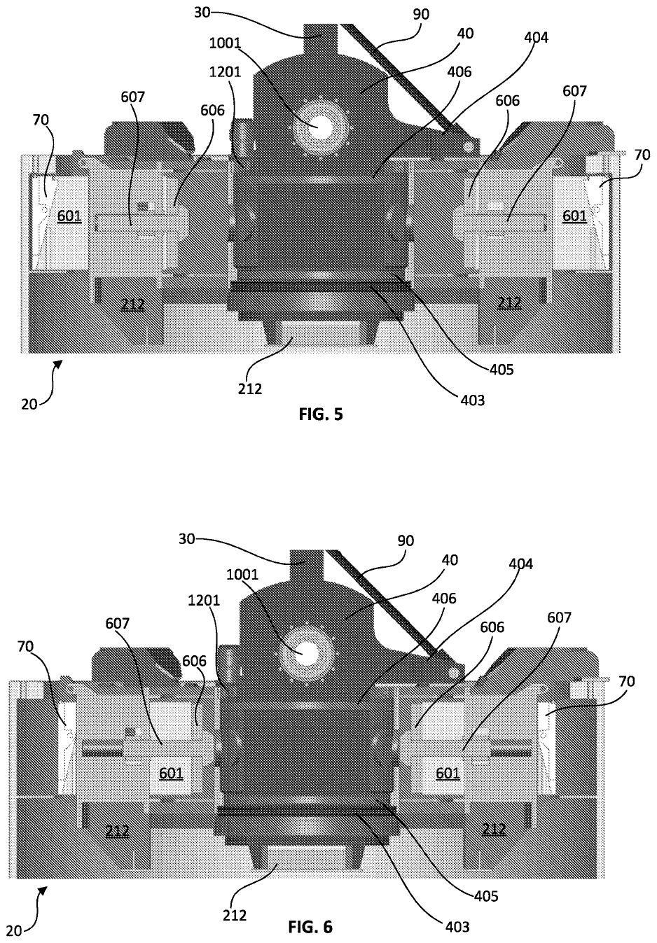

FIG. 5 is a central section side view of the upending device of FIG. 1, in a flange lifting mode with the connection elements retracted;

FIG. 6 is a central section side view of the upending device of FIG. 1, in a flange lifting mode with the connection elements extended;

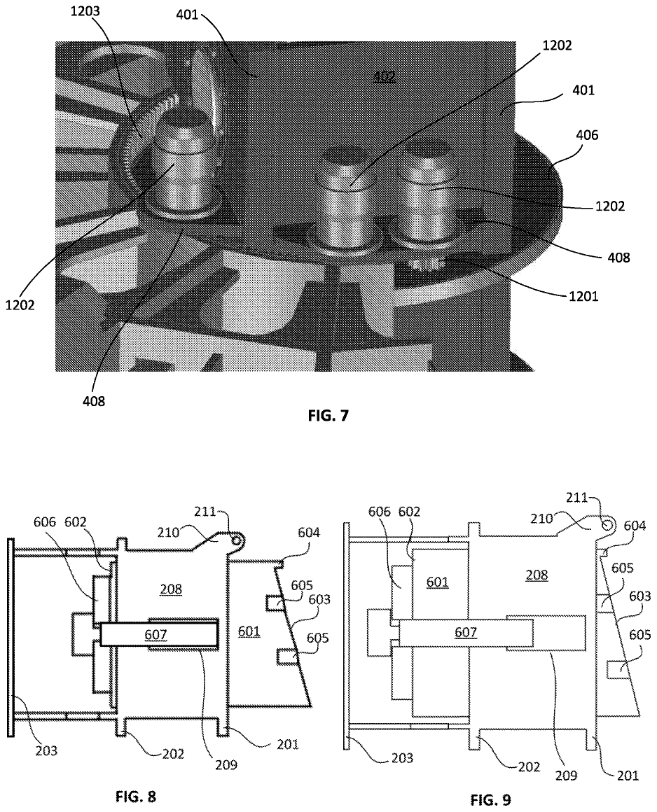

FIG. 7 is a detailed view of the driving means of the mounting element of the upending device of FIG. 1;

FIG. 8 is a detailed view of a connection element of the upending device of FIG. 1, in an extended configuration;

FIG. 9 is a detailed view of the connection element of FIG. 8, in a retracted configuration;

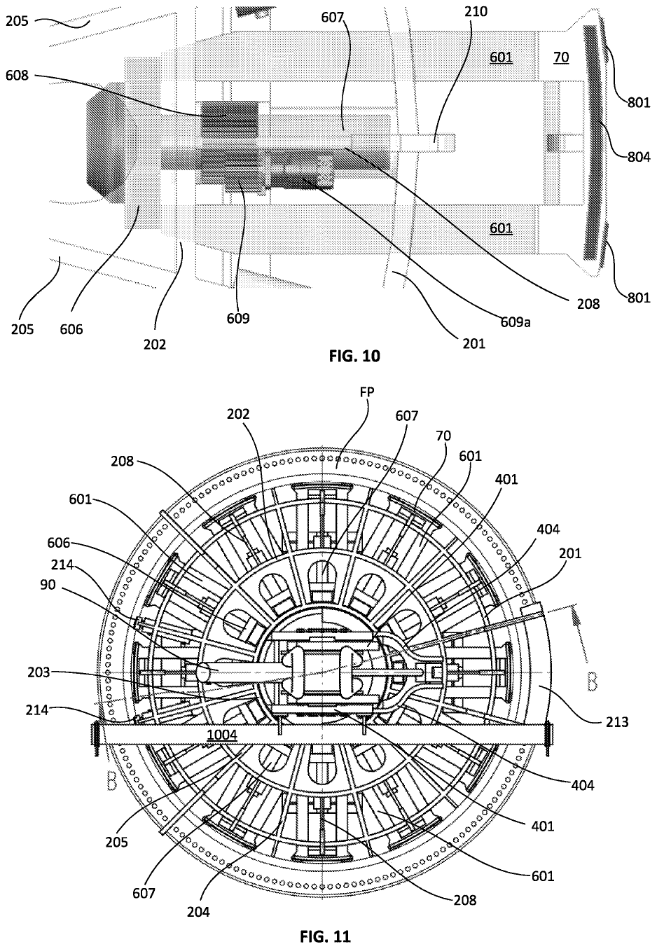

FIG. 10 is a top view of the connection element of FIG. 8;

FIG. 11 is a top view of the upending device of FIG. 1, in the retracted configuration, located in a flanged tubular pile;

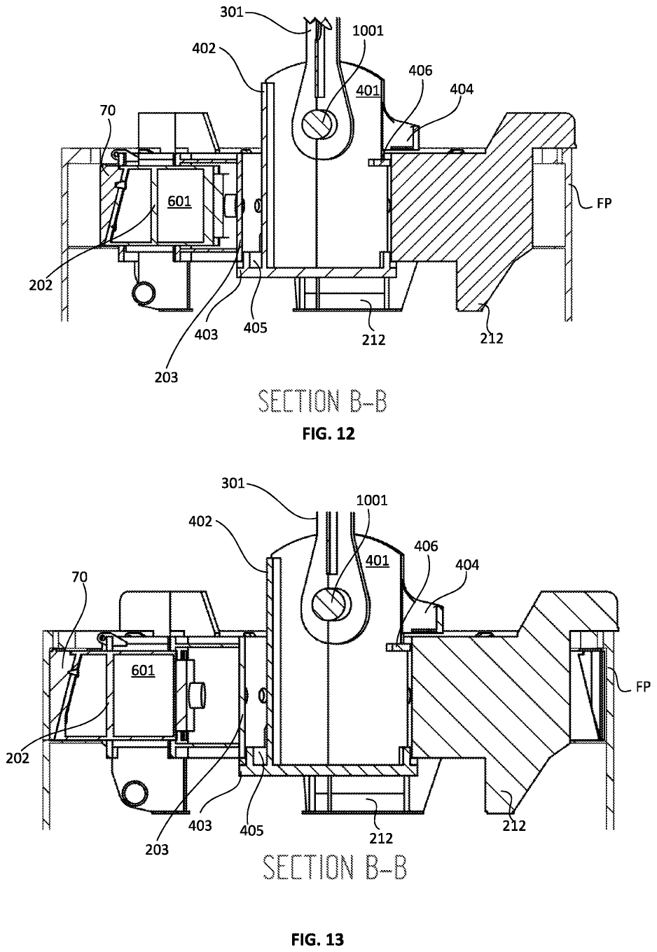

FIG. 12 is a section view along line BB of the upending device of FIG. 11, in the retracted configuration, located in the flanged tubular pile;

FIG. 13 is a section view along line BB of the upending device of FIG. 11, in the extended configuration, located in the flanged tubular pile;

FIG. 14 is a top view of the upending device of FIG. 1, in the retracted configuration, located in an un-flanged tubular pile;

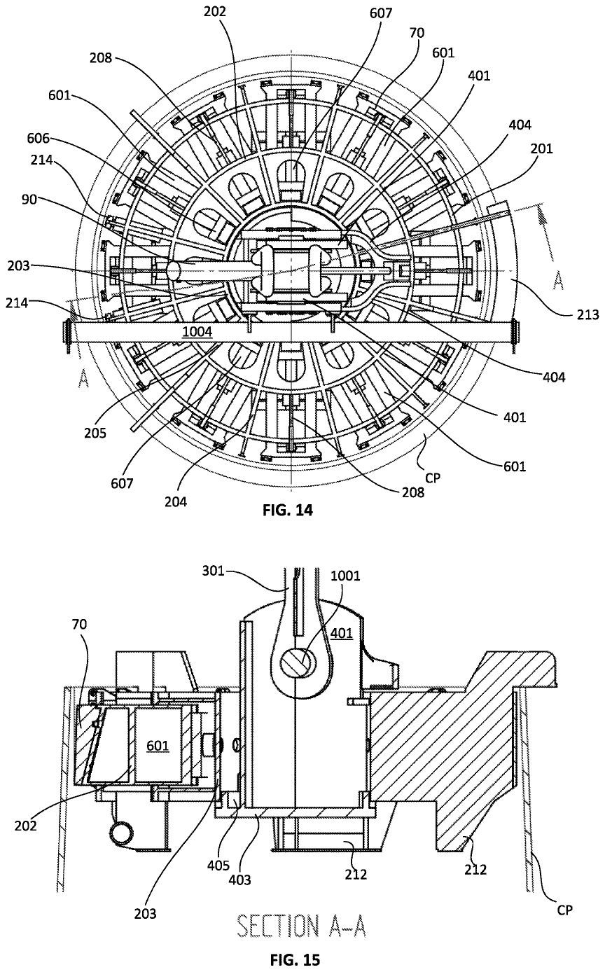

FIG. 15 is a section view along line AA of the upending device of FIG. 14, in the retracted configuration, located in the un-flanged tubular pile;

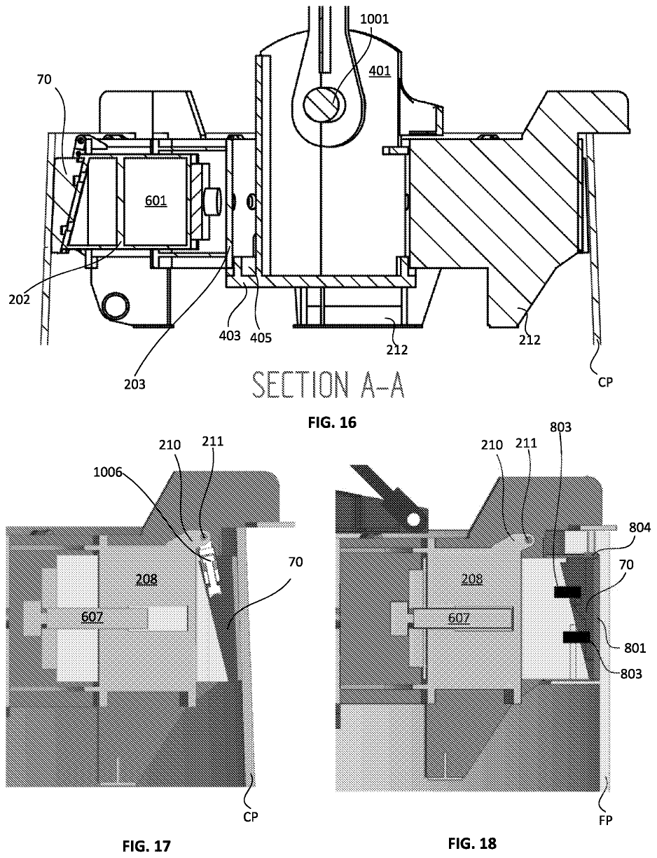

FIG. 16 is a section view along line AA of the upending device of FIG. 14, in the extended configuration, located in the un-flanged tubular pile;

FIG. 17 is a detailed view of the connection element with an engagement part located in an un-flanged pile;

FIG. 18 is a detailed view of the connection element with an engagement part located in a flanged pile;

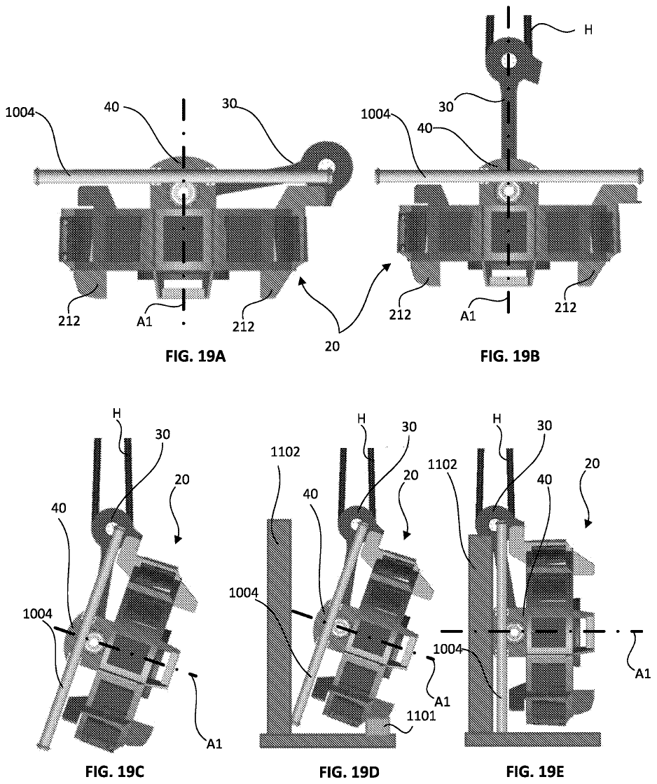

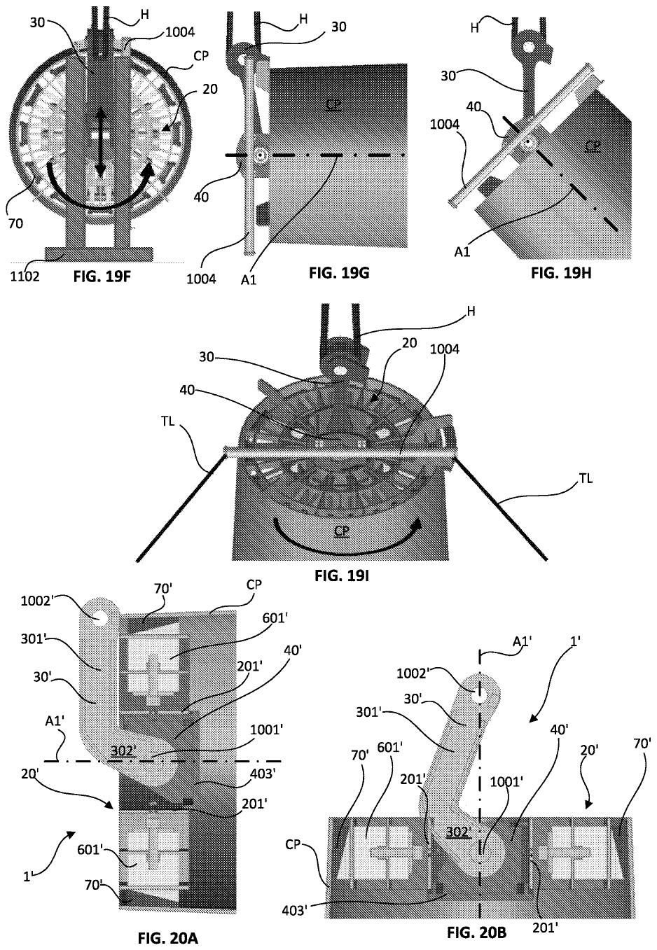

FIG. 19A-I illustrates an upending process of a pile using the upending device of FIG. 1;

FIG. 20A-B is a section review of an upending device according to another embodiment of the invention;

FIG. 21 is a side view of the upending device according to another embodiment of the invention, with a hoisting element controller;

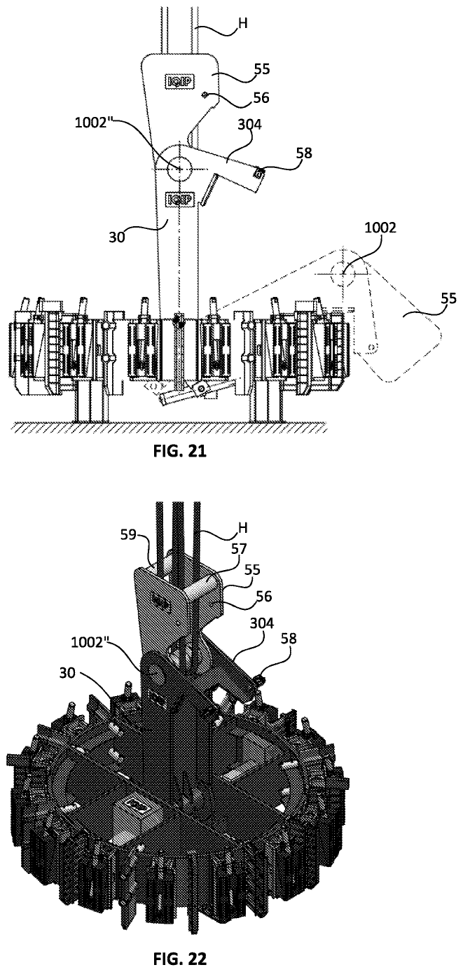

FIG. 22 is an isometric view of the pile upending device of FIG. 21; and

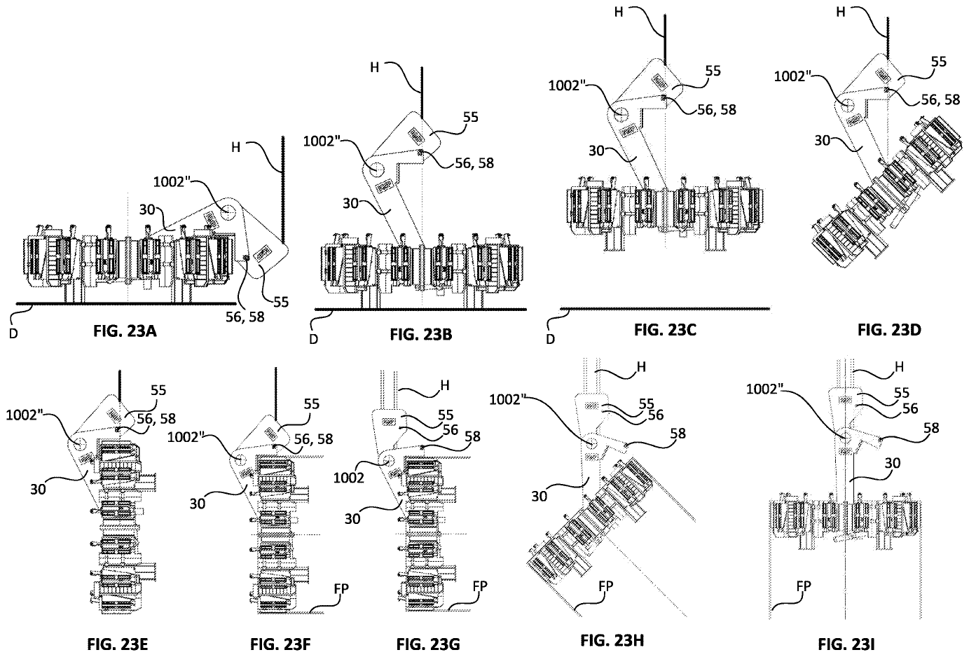

FIG. 23 shows operating steps A-I of upending a pile using the pile upending device of FIG. 21.

The Figures show an upending device 1. The upending device 1 has a base element 20, a plurality of connection elements and a lifting arm 30. The base element 20 and plurality of connection elements are for insertion into an end of, and for extending along an inside of, a tubular pile FP, CP (for example as visible in FIGS. 11-18). Each connection element is connected to the base element 20 and is configured to engage with one or more inside surfaces of the tubular pile. The lifting arm 30 is for coupling the upending device 1 to a hoisting element H.

In this example the base element 20 has three rings, namely an outer ring 201, an intermediate ring 202 and an inner ring 203. The rings 201, 202, 203 are concentric with one another. A plurality of outer webs 204 connect the outer ring 201 and the intermediate ring 202 together. A plurality of inner webs 205 connect the intermediate ring 202 and the inner ring 203 together.

The lifting arm 30 is rotatably coupled to the base element 20. The lifting arm 30 is rotatable relative to the base element about a first axis A1. The first axis A1 is a central axis of the base element 20. The first axis A1 is substantially parallel to a central axis of the tubular pile, in use. In use, the base element 20 and connection elements are rotatable about the first axis A1 to align the connection element with desired engagement locations on one or more inside surfaces of the tubular pile, for example to prevent engagement at unsuitable areas such as at weld areas. When the connection elements are then engaged with the one or more inside surface of the tubular pile, the hoisting element H can be used to lift the lifting arm 30 to upend the tubular pile. The upending device 1 may also be used to deploy the pile or downend the pile. The base element 20 and connection elements can be rotated about the first axis A1 when the pile is fully suspended form the hoisting element H to change the heading of the tubular pile.

Advantageously, the base element 20 and connection elements are rotatable, about the first axis A1, to avoid engagement between the connection elements being at, or at least to reduce the risk that engagement between the connection elements is at, suboptimal locations, such as at weld locations, in the pile. Further advantageously, the base element 20 and connection elements may be rotatable about the first axis A1, when inserted into the tubular pile, to vertically align two of the connection elements. This may aid in centralising the upending device 1 in the pile, because engagement of the vertically aligned connection elements can be used to align the upending device in the vertical direction. Furthermore, these vertically aligned connection elements can be engaged with the tubular pile first, to further aid in centralising the upending device 1 in the tubular pile. Further advantageously, the heading of the pile is alterable during deployment, by rotating the base element 20 and the connection elements about the first axis A1. Thereby, the heading of the pile can be fine-tuned. This may be advantageous in controlling the heading of the pile as it is lowered to the ground into which it will be driven. This may also be advantageous when the pile is in two parts which are bolted together along the length thereof, such that a first part of the pile is supported on a surface in an upright configuration, and a second part is lowered onto the first part such that they can be bolted together. Rotating the second part of the pile about the first axis means that the bolt holes in the first and second parts of the pile can be easily aligned for connecting the two parts together.

The lifting arm 30 may be rotatable relative to the base element about the first axis A1 with any suitable means. In this example the upending device 1 has a mounting element 40. The mounting element 40 may also be referred to as a swivel connector. The mounting element 40 provides an intermediate frame between the lifting arm 30 and the base element 20. The mounting element 40 is rotatably coupled to the base element 20. The mounting element 40 is rotatable relative to the base element 20 about the first axis A1. In this manner, the orientation of the lifting arm 30 relative to the first axis A1 can be decoupled from the orientation of the base element 20 relative to the first axis A1.

The mounting element 40 may be rotatably coupled to the base element 20 with any suitable means. In this example the mounting element 40 is mounted to the base element 20 via radial bearings as described below.

In this example, the mounting element 40 has two, parallel connection plates 401 with aligned apertures through each one. Extending between the two connection plates 401 is a first support web 402. The first support web 402 is located proximal a first side of each connection plate 401. As is best shown in FIGS. 5 and 6, the mounting element 40 has an axial bearing, for example a thrust bearing 403 mounted to a first end, that is a first axial end, the first end being the furthest end from the apertures through the connection plates 401. Surrounding and attached to each connection plate 401, proximal the axial bearing 403, is a first radial bearing 405. Surrounding and attached to each connection plate 401, at a position spaced from the axial bearing 403, is a second radial bearing 406. Extending from one side of each connection plate 401, between the second radial bearing 406 and a second end, that is a second axial end, of the mounting element, is an actuator support 404. The second end is at the opposite axial end of the mounting element 40 to the first end. The actuator support has two side plates which converge to two parallel mounting plates, each mounting plate have an aperture therethrough which is aligned with the aperture of the other mounting plate. Located on an outward facing surface of one of the connection plates 401, between the second radial bearing 406 and the second end of the mounting element 40, are two anti-rotation tube mounts 407. The first and second radial bearings 405, 406 may be roller bearings, ball bearings or radial sliding bearings, for example.

During assembly of the upending device 1, the radial bearings 405, 406 are mounted to the connection plates 401 of the the mounting element 40, and the radial bearings 405, 406 are located in the inner ring 203 of the base element 20. The axial bearing 403 of the mounting element 40 is attached to the connection plates 401. The axial bearing 403 is located outside of the inner ring 203 at one end of the inner ring 203. The actuator support 404 and apertures through the connection plates are located outside of the inner ring 203 at the other end of the inner ring 203.

The mounting element 40 may include any suitable means for rotating the mounting element 40 relative to the base element 20. In this example, and as best shown in FIG. 7, the upending device 1 includes a plurality of pinions 1201, or rotatable gears, coupled to pinion mounting plates 408 which extend from any number of the connection plates 401 and the first support web 402 of the mounting element 40. The pinion mounting plates 408 are located between the second radial bearing 406 and the second end of the mounting element 40 The upending device 1 also includes a gear rotation means 1202, which in this case is an electric or hydraulic motor, associated with each pinion 1201, to drive rotation of the respective pinion 1201. In this example there are three pinions 1201. In this example one of the pinions 1201 is redundant but can be activated in the event of failure of one of the other pinions 1201. Mounted to a radially inside surface of the inner ring 203, and extending around the circumference thereof, of the base element 20 is a gear rack 1203. The gear rack 1203 is located proximal the end of the inner ring 203 which faces the lifting arm 30. The pinions 1201 are engaged with the gear rack 1203 such that rotation of the pinions 1201 moves the pinions 1201 along the gear rack 1203, thereby rotating the mounting element 40 relative to the base element 20.

In this example, the lifting arm 30 has two parallel plates 301 connected together by a central web 302. Each plate 301 of the lifting arm 30 has a beam shaped central section and bulb-shaped end sections at either end of the central section. The end sections each have a central aperture. The central web 302 extends between the central sections of the parallel plates 301. The lifting arm has actuator mounting portions 303 which are extensions of each plate 301, located partway along the central section of the respective plate 301. Each actuator mounting portion 303 has an aperture therethrough, which is aligned with the aperture in the actuator mounting portion 303 of the other plate 301. The lifting arm 30 has stand portions 304, which are extensions of one end section of each plate 301. The stand portions 304 extend from a side of the respective end section. It would be understood that other constructions of lifting arm 30 are also possible.

In this example, the lifting arm 30 is rotatably coupled to the mounting element 40. The lifting arm 30 is rotatable relative to the mounting element 40 about a second axis A2. The second axis A2 is perpendicular to the first axis A1. As described later with respect to FIGS. 19A-I, the lifting arm 30 is rotatable, about the second axis A2, during lifting of the upending device by the hoisting element H. The base element 20 and connecting elements are also rotatable about the second axis, relative to the lifting arm 30, to move the central axis of the base element 20 closer to horizontal for insert of the base element 20 and connecting elements into the tubular pile. In this example the rotatable coupling between the lifting arm 30 and the mounting element 40 includes a bearing, such as a roller or ball bearing, secured to the aperture of each connection plate 401 of the mounting element 40. A first shaft 1001 is rotatably supported between the two bearings. The first shaft 1001 passes through the aperture in end sections of the plates 301 of the lifting arm 30, these end sections being those which do not have the stand portion 304 extending therefrom. Thereby, the lifting arm 30 is rotatable about the second axis A2 relative to the mounting element 40.

In this example the lifting arm 30 is rotated relative to the mounting element 40 by linear actuator 90. As described later with regards to FIGS. 19A-151, the linear actuator 90 is contracted to rotate the base element 20 relative to the lifting arm 30, to move the central axis of the base element 20 closer to being horizontal.

An end connector at an end of the piston of the linear actuator 90 is rotatably connected to the mounting plates of the actuator support 404 of the mounting element 40. The connection between the end connector of the linear actuator 90 and the mounting plates of the actuator support 404 is via a pin passing through the apertures in the mounting plates and through the end connector of the linear actuator 90. Located partway along a cylinder of the linear actuator 90 is a connection feature, the connection feature being rotatably connected to the actuator mounting portion 303 of the lifting arm 30. When the linear actuator 90 is in a retracted configuration, an axis of the lifting arm 30, which passes through the centres of the apertures at each end section of the plates 301 of the lifting arm 30, is substantially parallel with the radial direction of the rings 201, 202, 203 of the base element 20.

Referring now to FIGS. 8 and 9, a connection part 601 of a connection element of the upending device 1 is shown. In this example, the connection part 601 includes a first, radially inner, end 602 and a second, radially outer, end 603 (shown to the right in FIGS. 8 and 9). A radially outer portion, corresponding to the second end 603 is tapered along the height direction (the vertical direction in FIGS. 8 and 9). The radial thickness of the radially outer portion is tapered (that is, reduces in thickness) towards the side of the base element 20 on which the lifting arm 30 is located. The second end 603 includes a coupling surface facing radially outwardly.

At one end of the coupling surface, which corresponds to a shorter length of the connection part 601, there is an overhang 604 extending in the length direction of the connection part 601. Each connection part 601 has two connection means 605 at the second end. In this example the connection means 605 are blind holes or recesses which start from the coupling surface and extend in the length direction of the respective connection part 601. The holes or recesses may be threaded.

As best shown in FIG. 11, in this example each connection part 601 is arranged in a group of two, parallel connection parts 601. It would be understood, however, that a single connection part 601, or more than two parallel connection parts 601 may be used.

Each connection part 601 is movable in the radial direction relative to the tubular pile in use. For example FIG. 8 shows the connection part 601 in a position more radially outwardly compared to the connection part 601 in FIG. 9.

Each connection part 601 could be moved radially with any suitable means. In this example each connection part 601 is moved radially by way of a threaded drive shaft 607, the rotation of which displaces the connection part 601 relative to the base element 20.

As best shown in FIGS. 8-10, in this example each group of two connection parts 601 is connected at the first end 602 by a driving plate 606 which extends between, and is attached to, the two connection parts 601. The driving plate 606 has a central aperture therethrough which the drive shaft 607 extends through. The drive shaft 607 has an enlarged head which is sized to be prevented from passing through the central aperture in the respective driving plate 606. Each drive shaft 607 may also have a collar, or retainer, to prevent the drive shaft from being removed from the driving plate 606 without first removing the collar. Each drive shaft 607 has an external thread (not shown), for example a trapezoidal thread. Each connection element has a gear nut 608. Each gear nut 608 has an external gear, for example a spur gear or a helical gear. Each gear 608 nut has an internal thread (not shown), for example a trapezoidal thread. Each gear nut 608 is mounted to the intermediate ring 202 of the base element 20, such that the gear nut 608 can rotate but is restrained axially. Each connection element has a driving pinion 609. Each driving pinion has a driving pinion drive means 609a, for example an hydraulic drive or an electric motor. Each driving pinion 609 and driving pinion drive means 609a is mounted to the base element 20, in this example to a corresponding driving web 208, which is located between each outer web 204, extending between the outer ring 201 and the intermediate ring 202.

A side view, that is a circumferential view with respect to the base element 20, of one of the driving webs 208 is shown in FIGS. 8 and 9. Each driving pinion 609 is engaged with the external gear of the respective gear nut 608. The internal thread of each gear nut 608 is engaged with the external thread of the respective drive shaft 607. Rotation of each driving pinion 609 rotates the respective gear nut 608 which drives the respective drive shaft 607 in a radial direction relative to the base element 20. In this way the connection parts 601 are moved in the radial direction between an extended position, as shown in FIG. 8, and a retracted position, as shown in FIG. 9.

In this example each ring of the base element 20 includes a plurality of apertures therethrough, each aperture corresponding to a connection element. Each aperture in the outer ring 201 is aligned with a corresponding aperture in the intermediate ring 202. The apertures provide guides for radial movement of the respective connection part.

Specifically, the outer ring 201 has a plurality of first apertures 206 arranged in groups of two first apertures 206. The first apertures 206 extend through the outer ring 201 in the radial direction. The intermediate ring 202 has a plurality of second apertures 207 arranged in groups of two second apertures 207. The second apertures extend through the intermediate ring 202 in the radial direction. The distance between the two first apertures 206 in each group of two first apertures 206, in a direction perpendicular to the radial direction of the outer ring 201, is the same as the distance between the two second apertures 207 in each group of two second apertures 207, in a direction perpendicular to the radial direction of the intermediate ring 202. Each group of two first apertures 206 is aligned with a corresponding group of two second apertures 207. That is, a line passing through the centre of one first aperture 206 of each group of two first apertures 206 and a corresponding one second aperture 207 of the corresponding group of two second apertures 207 is parallel to the radial direction of the rings 201, 202, 203 of the base element 20.

All of the first and second apertures 206, 207 are of substantially the same in-plane size and shape.

In this example, at an end of each driving web 208, at an axial end of the outer ring 201 on the side of the base element 20 on which the lifting arm 30 is located, is a connection means 210. The connection means 210 is an extension of the respective driving web 208. The connection means 210 extends axially away from the outer ring 201 and radially outwardly. Each connection means 210 has a connection hole 211 therethrough.

Each connection part 601 extends through a respective one of the first apertures 206 in the outer ring 201 and through a respective one of the second apertures 207 in the intermediate ring 202. The first end 602 of each connection part 601 is located radially inward of the intermediate ring 202, and the second end 603 of each connection part 601 is located radially outward of the outer ring 201. In this way each driving plate 606 is located between the inner ring 203 and the intermediate ring 202.

Referring now to FIGS. 17 and 18, each connection element includes an engagement part 70. In this example, the connection element is configurable into a frictional lifting configuration or a flange lifting configuration. The connection element is shown in the frictional lifting configuration in FIG. 17 and in the flange lifting configuration in FIG. 18. In general in the frictional lifting configuration the engagement parts 70 are configured to provide frictional engagement with inside surfaces of the tubular pile and in the flange lifting configuration the engagement parts 70 are configured to provide engagement with a flange of the tubular pile.

In this example, the engagement parts 70 have coupling portions which are tapered in profile, with the radial thickness tapering away from the side of the base element 20 on which the lifting arm 30 is located. The coupling portions of each engagement part 70 includes a coupling surface facing radially inwardly.

In use, the connection parts 601 are radially moveable to bring the engagement parts 70 into abutment with the inside surfaces of the tubular pile. As will become clear from the following description, it will be appreciated that the amount of radial movement of the connection part 601 required to bring the engagement parts 70 into abutment with the inside surfaces of the tubular pile will depend on a number a number of factors—for example the configuration of the connection element (i.e. the frictional lifting configuration or the flange lifting configuration) and the internal diameter of the tubular pile.

In this example, the coupling surface of each engagement part is formed by elongate bosses as described herein. As best shown in FIGS. 3 and 4, the engagement parts 70 each have a facing plate. Two parallel and elongate bosses 702 extend radially inwardly from the facing plate. Each boss 702 is tapered, such that the thickness of the boss 702, away from the facing plate, tapers with distance along the boss 702. Extending between the two bosses 702, is an actuator connection plate (not shown) with an aperture therethrough. The radially inner surface of each boss 702 has an axial locking means 803. In this example the axial locking means 803 is in the form of two apertures which extend into the respective boss 702. Locking devices, for example pins, which are received in the axial locking means 803 are indicated schematically in FIG. 18. As best shown in FIG. 3, the engagement parts 70 in the frictional lifting configuration has two, parallel strips of teeth 701 connected to the facing plate. The strips of teeth 701 are tapered, in that the thickness of the strips of teeth 701, away from the facing plate, is tapered over the length of each strip of teeth 701. The strips of teeth 701 are parallel with, and aligned to the bosses 702. The taper of each strip of teeth 701 is in the opposite direction to that of each boss 702.

As best shown in FIG. 4, the engagement parts 70 in the flange lifting configuration have two, parallel radial rails 801 on the radially outer surface of the facing plate. The strips 801 are parallel with, and aligned to, the bosses 702. An axial surface of each engagement part 70, which faces the lifting arm 30 in use, has an axial rail 804 attached thereto. Each axial rail is aligned in the circumferential direction relative to the base element 20. Each axial rail and radial rails may be a sliding bearing, for example made from a composite material.

Each connection element of the upending device 1 is switchable between the frictional lifting configuration and a flange lifting configuration. This switches the upending device 1 between a frictional lifting mode and a flange lifting mode. In FIGS. 1 and 3 the upending device 1 is in a frictional lifting mode and in FIGS. 2 and 4 the upending device 1 is in a flange lifting mode. Configuring the upending device 1 into the frictional lifting mode includes detaching any radial and/or axial rails 801, 804 which are attached to engagement parts 70, and attaching the two strips of teeth 701 to each engagement part 70. The locking devices received in the axial locking means 803 (if present) are removed. Configuring the upending device 1 into the frictional lifting mode also includes attaching an actuator 1006 between the actuator connection plate of each engagement part 70 and the connection means 210 of the respective driving web 208 of the base element 20. The actuator 1006 is for moving the engagement part 70 along the coupling surface of the connection part 601 as described further below.

Configuring the upending device 1 into the flange lifting mode includes detaching any strips of teeth 701 which are attached to engagement parts and attaching two axial rails 804 and two radial rails 801 to each engagement part 70. Configuring the upending device 1 into the flange lifting mode also includes inserting locking devices into the axial locking means 803 to connect each engagement part 70 to the respective connection part 601.

It would be understood that the upending device 1 may also be switched between the frictional lifting mode and the flange lifting mode by switching between a set of engagement parts 70 which have strips of teeth 701 attached thereto, and a set of engagement parts 70 which have radial and axial rails 801, 804 attached thereto. In the frictional lifting mode each engagement part of the set of engagement parts 70 with the strips of teeth 701 attached are placed on the respective connection part 601, and one of the actuators 1006 is connected between the actuator connection plate of the engagement part 70 and the connection means 210 of the of the respective driving web 208. The actuator 1006 is for moving the engagement part 70 along the coupling surface of the connection part 601 as described further below. In the flange lifting mode each engagement part 70 of the set of engagement parts 70 with the radial and axial rails 801, 804 attached are placed on the respective connection part 601 and the locking devices are inserted into the axial locking means 803 to connect each engagement part 70 to the respective connection part 601. Advantageously, by providing the ability to change the configuration of the same upending device 1 to be usable with both a flanged pile FP and an un-flanged pile CP, the complexity of operation is reduced, as operation of the upending device 1 is similar in both configurations. This also reduces expenditure as only one upending device 1 needs to be obtained and maintained. This also reduces the amount of space required, for example on an offshore vessel (not shown), for upending devices 1. Further advantageously, the base element 20 and connection elements are insertable into an end of the pile which has a smaller internal diameter than the diameter at the location where the connection elements engage the pile, by inserting the base element 20 while the connection elements are in a radially retracted position. Again, this means that the upending device 1 is suitable for use with flanged piles FP and un-flanged piles, for example un-flanged conical piles CP. That is, this means that the upending device 1 is suitable for insertion into a flanged end of a flanged pile FP, and for insertion into a narrowest end of a conical, un-flanged pile CP.

Referring now to FIGS. 11-13 and FIG. 18, the assembly of the upending device 1 for use with a flanged pile FP, is shown. When the upending device 1 is to be used with a flanged pile FP, one of the engagement parts 70, with the radial and axial rails 801, 804 attached thereto, is attached to each group of two connection parts 601 via engagement between the axial locking means 803 of each engagement part 70 and the connection means 605 at the second end of the respective connection parts 601. The axial locking means 803 restrict axial movement of the engagement part 70 relative to the connection part 601.

When the upending device 1 is used with a flanged pile FP, the base element 20 is located inside of the flanged end of the pile FP. The connection element is in the retracted position. The drive shafts 607 are then rotated to drive the connection parts 601 and the engagement parts 70 in a radially outward direction, such that the engagement parts 70 engage an inside surface of the flange of the flanged pile FP. That is, the radial rails 801 attached to each engagement part 70 abuts, or is at least proximal, a radial inside surface of the pile. The axial rail 804 contacts an inside axial surface of the flange of the pile.

Referring now to FIGS. 14-17 the assembly of the upending device 1 for use with an un-flanged, conical pile CP, is shown. When the upending device 1 is to be used with an un-flanged pile CP, one of the engagement parts 70, with strips of teeth 701 attached thereto, abuts each group of two connection parts 601 such that the tapered second end of the respective connection part 601 is in slidable contact with the radially inner surface of each boss 702 of the respective engagement part 70. The tapered bosses 702 of each engagement part 70 are orientated inversely to the taper of the respective connection parts 601. That is, the thickest part of each boss 702 of the engagement part 70 contacts the coupling surface of the corresponding connection part 601 at the side proximal the shortest length of the connection part 601. One end of a linear actuator 1006 is connected to the connection hole 211 through the respective connection means 210 of the base element 20. The other end of each linear actuator 1006 is connected to the actuator connection plate of the corresponding engagement part 70. Thereby, extension and retraction of one of the linear actuators 1006 slides the respective engagement part 70 over the coupling surface of the respective connection parts 601, which displaces the respective engagement part 70 radially outwardly. The overhang 604 prevents the engagement part 70 from sliding upwardly, which may otherwise occur during the upending phase.

When the upending device 1 is used with an un-flanged pile CP, the base element 20 is located inside of the narrowest end of the pile CP. The connection element is in the retracted position.

The drive shafts 607 are then rotated to drive the connection parts 601 and the engagement parts 70 close to, or into contact with, a radially inside surface of the pile CP. The linear actuator 1006 is then extended to push each engagement part 70 along the coupling surface of the respective connection part 601, such that the teeth of the engagement parts 70 engage with the radial inner surface of the pile CP.

Referring now to FIGS. 19A-I, an upending procedure is described. In FIGS. 19A-I the upending procedure is illustrated with an un-flanged pile CP, but it will be appreciated that the process is similar when used to upend a flanged pile FP.

The base element 20 has four legs 212. Each leg 212 is partly formed of an extension of two of the outer webs 204. The two extensions of the outer webs 204, of each leg 212, are connected together by a foot. The two extensions of the outer webs 204, of each leg 212, extend from a first side of the outer webs 204, the first side being the opposite axial side of the outer webs 204 to the side on which the lifting arm 30 is located. The first sides of the outer webs 204 face downwards when the upended device 1 is in storage. The base element 20 also has a platform 213. The platform 213 is formed of extensions of two outer webs 204. The extensions are connected together by a flat plate. The two extensions of the outer webs 204, of the platform 213, extend from a second side of the outer webs 204, the second side being the axial side of the outer webs 204 on which the lifting arm 30 is located. The second sides of the outer webs 204 face upwards when the upended device 1 is in storage.

As shown in FIG. 19A the upending device 1 is stored with the upending device 1 standing on the legs 212 of the base element 20.

A second shaft 1002 is secured between the apertures of each plate 301 of the lifting arm 30 at the end section which has the stand portion 304 extending therefrom. A pulley wheel 1003 is rotatably mounted to the second shaft 1002.

As shown in FIG. 19B, the hoisting element H is attached to the pulley wheel 1003, and the linear actuator 90 (not shown in FIGS. 19A-I) is extended as tension is applied to the hoisting element H, such that the lifting arm 30 rotates about the first shaft 1001, and about the second axis A2, relative to the mounting element 40. The upending device 1 is then lifted from the surface on which it is stored by the hoisting element H. During this movement the central axis of the base element 20 is substantially vertical.

As shown in FIG. 19C, the linear actuator 90 is contracted to rotate the base element 20 relative to the lifting arm 30, to move the central axis of the base element 20 closer to being horizontal.

As shown in FIG. 19D, the upending device 1 is lowered onto a temporary support 1101 on an installation frame 1102. The temporary support 1101 contacts one of the legs 212 to cause the upending device 1 to rotate such that the central axis of the base element 20 is substantially horizontal, when the upending device 1 is lowered onto the temporary support 1101.

Advantageously, the leg 212 can be aligned with the temporary support 1101 by rotating the base element 20 about the first axis A1.

As shown in FIG. 19E, when the central axis of the base element 20 is substantially horizontal the upending device 1 is temporarily connected to the installation frame 1102. The temporary support 1101 is then removed.

As shown in FIGS. 19F and 19G, the upending device 1 and installation frame 1102 are moved, via the hoisting element H, to the proximity of the pile. The central axis of the base element 20 is then aligned with the central axis of the pile by skidding the installation frame 1102 in a direction perpendicular to these axes. The base element 20 and the connection elements are inserted into the end of the pile with the connection elements in the retracted position, by skidding the installation frame 1102 towards the pile. The platform 213 contacts an upper surface, or rim, of the pile once the upending device 1 is inserted into the pile.

Once the base element 20 and connection elements are inserted into the end of the pile, and while the connection element are retracted, the base element is rotated, relative to the mounting element 40, about the first axis, such that the connection elements are optimally aligned with the inside surface or surfaces of the pile. This enables one or two connection elements to be orientated vertically, such that these connection elements can be extended before the other connection elements, to aid in centralising the upending device 1 in the pile. Rotation of the base element 20 and connection elements about the first axis A1 also avoids the contact force between the pile and the connection elements being at inopportune positions, such as at weld locations. Located on the outer ring 201 of the base element 20 are a plurality of guiding elements, which are centralisers 214, and which are visible in FIGS. 3 and 4. The centralisers 214 are pistons which are extendable radially outwardly from the outer ring 201. Centraliser driving means (not shown) for extending the centralisers radially outwardly are provided radially inside of the outer ring 201. In this example the centralisers 214 are provided in groups of two, circumferentially aligned, centralisers 214. In the example there are four groups of two centralisers 214 at locations which are equally spaced around the circumference of the outer ring 201. However, there may be two, three or more groups of centralisers.

The centralisers 214 of the base element 20 are then extended radially outwardly to centralise the base element 20 within the pile. The vertically aligned connection elements are then extended. In the case of use with an un-flanged pile CP, the linear actuators 1006 connected to the vertically aligned connection elements are extended such that the engagement parts 70, with strips of teeth 701 attached thereto, of these connection elements engage with the radially inner surface of the pile. In the case of use with a flanged pile FP, the drive shafts 607 of the vertically aligned connection elements drive the connection elements radially outwards until the engagement parts 70, with radial and axial rails 801, 804 attached thereto, engage with the flange of the pile FP. This engagement between the vertically aligned connection elements and the inside surfaces of the pile further ensures that the base element 20 is centralised in the pile. The remainder of the connection elements are then extended to engage with the inside surfaces of the pile. That is, in the case of use with an un-flanged pile CP, the linear actuators 1006 connected to the remaining connection elements are extended such that the engagement parts 70, with strips of teeth 701 attached thereto, of these connection elements engage with the radially inner surface of the pile. In the case of use with a flanged pile FP, the drive shafts 607 of the remaining connection elements drive the connection elements outwards until the engagement parts 70, with radial and axial rails 801, 804 attached thereto, engage with the flange of the flanged pile FP. The installation frame 1102 is then disconnected from the upending device 1 and is removed therefrom. As shown in FIG. 19H, the upending device 1 is then lifted by the hoisting element H, to lift the end of the pile. The lifting arm 30 is rotated about the second axis A2, by extending the linear actuator 90 which is connected between the lifting arm 30 and the mounting element 40, during lifting of the pile.

An anti-rotation beam 1004 is secured to the anti-rotation beam mounts 407 on the mounting element 40. The anti-rotation beam 1004 is perpendicular to the central axis of the base element 20. The anti-rotation beam 1004 is tubular in shape.

As shown in FIG. 19I, when the pile is suspended vertically, tugger lines TL are connected to either end of the anti-rotation beam 1004, to prevent the lifting arm 30 and the mounting element 40 rotating. The heading of the pile can then be altered by rotating the base element 20 and connection elements about the first axis A1.

The pile can then be stabbed into the ground, held upright by a pile gripper, and pile driven into the ground.

Referring now to FIGS. 20A and 20B, there is shown an upending device 1′ according to a second embodiment of the invention. The upending device 1′ has similar features to those described with reference to the upending device 1 described with reference to FIGS. 1-191, and similar features are denoted with the same reference numerals with a succeeding prime (′). Only features of this upending device 1′ which differ from those of the previous embodiment are described herein.

The upending device 1′ of this embodiment differs from the previous embodiment in that the lifting arm 30′ has a first section 301′ and a second section 302′, the first section 301′ being at an oblique angle to the second section 302′. The upending device 1′ of this embodiment differs from the previous embodiment in that the mounting element 40′ is substantially level with the side of the base element 20′ which faces the lifting arm 30′. The end of the lifting arm 30′ which is connected to the first shaft 1001′ is therefore coupled to the mounting element 240′ at a position radially inside of the inner ring 201′ of the base element 20′. The oblique angle between the first and second sections 301′, 302′ of the lifting arm 30′ means that the when the central axis of the base element 20′ is aligned with the pile in the horizontal orientation, as shown in FIG. 20A, the first section 301′ is perpendicular to the central axis of the base element 20′. When the pile is suspended in the vertical orientation, as shown in FIG. 20B, the first and second shafts 1001′, 1002′ are vertically aligned.

FIGS. 21 and 22 show another example of an upending device, wherein the lifting arm 30 comprises a hoisting element controller 55 being rotatably connected to the lifting arm 30 by means of a second shaft 1002″. The hoisting element controller 55 comprises a pair of spaced apart plates, wherein in their lower section each plate comprises an aperture or opening to pivotably engage with the second shaft 1002″. The hoisting element controller 55 further comprises first and second connecting elements 57, 59 connecting the spaced apart plates together. The hoisting element H is routed through an opening defined by the connecting elements 57, 59 and the pair of spaced apart plates of the hoisting element controller 55. The hoisting element controller 55 can be rotated about the second shaft 1002″, which defines a third axis which is parallel to the second axis, between a first position, in which the hoisting element controller 55 is vertical when the lifting arm 30 is vertical and the centreline of the base element is vertical, and a second position, in which the hoisting element controller 55 is horizontal when the lifting arm 30 is vertical and the centreline of the base element is vertical. In the first position the hoisting element H is in its most extended form, most probably suspended from a hoisting machine (e.g. a crane). When the hoisting element controller 55 is in the second position the hoisting element H is in contact with the second connecting element 59.

Moreover, each of the hoisting element controller's plates comprise an opening 56 and the lifting arm 30 has two spaced-apart stand portions 304 extending therefrom, the stand portions 304 having locking elements 58 corresponding to the openings 56 in the hoisting element controller's plates when the hoisting element controller 55 is in the second position. Thereby, when the hoisting element controller 55 is rotated about the second shaft 1002″ from the first position to the second position, the hoisting element controller 55 can be locked, or secured to the lifting arm 30, in said second position by means of the locking elements 58 provided at each side of the stand portions 304. The locking elements 58 are configured to secured the position of the hoisting element controller 55, and consequently of the hoisting element H, relative to the lifting arm 30.

It should be appreciated that the upending device of this embodiment differs from the previous embodiments by the features described with reference to FIGS. 21 and 22, but that the remaining feature of the upending device are similar to those described with reference to previous embodiments.

Referring now to FIG. 23, the operation of the opening device of FIGS. 21 and 22 is now described. FIG. 23 shows steps A-I of upending a flanged pile FP. However, it will be appreciated that the steps would be the same for upending a conical pile with a suitable base element.

In step A the upending device is standing on a deck D, for example for storage or transportation. The centreline of the base element is vertical (when the vessel upon which the upending device is located is upright), the lifting arm 30 is in a stowed position in which it is rotated away from a lifting position, and the hoisting element controller 55 is in the second position. In this configuration, the stand portions 304 of the lifting arm 30 extend downwards along a radial side of the base element, and the hoisting element controller 55 is secured to the lifting arm 30 in the second position. The hoisting element H, connected to the second shaft 1002″ and passing through the opening defined by the connecting elements 57, 59 and the pair of spaced apart plates of the hoisting element controller 55, therefore extends vertically from the second connecting element 59. The connecting elements 59 are circular in cross-section, being either tubes or rods, and are connected at their ends to the spaced part plates. In other words, the hoisting element H extends from the second shaft 1002″ to the second connecting element 59, before it is able to extend vertically to the hoisting machine.

In step B, the lifting arm 30 is rotated relative to the base element into a lifting position, whilst the hoisting element connector 55 remains secured to the lifting arm 30 in the second position. The shape of each stand portion 304 means that the lifting line from the hoisting element H is along the centreline of the base element, even though the hoisting element H is curved around the second connecting element 59.

In step C, the upending device is lifted, using the hoisting element H, from the deck D whilst in the configuration described in step B.

In steps D and E the base element is rotated about the lifting arm 30 until the centreline of the base element is horizontal, as shown in step E. In this position, the stand portions 304 of the lifting arm 30 extend along a radial side of the base element. Advantageously, in the configuration shown in step E, the lifting line from the hoisting element H is along a centre of gravity (CoG) of the base element, of is at least closer to the centre of gravity than in previous embodiments. This enables easier stabbing of the base element into a pile.

In step F, the base element is stabbed into the end of the pile FP whilst in the configuration shown in step E.

In step G, the locking elements 58 of the stand portions 304 of the lifting arm 30 are disconnected from the openings 56 of the hoisting element controller 55, and the hoisting element controller 55 is rotated about the second shaft 1002″ to the first position.

In steps H and I the pile FP is upended by rotating the base element relative to the lifting arm 30. As is visible in step I, the loading line from the hoisting element H is along the centreline of the base element.

The skilled person will appreciate that the hoisting element controller 55 allows to have a displacement of the centre of gravity (CoG) of the upending device 1, especially when stabbing the upending device 1 into a horizontally positioned pile. This is applicable to either an un-flanged pile CP or a flanged pile FP. The CoG displaces towards the hoisting element controller 55, when the central axis of the base element 20 of the upending device 1 is aligned with the pile in the horizontal orientation. This allows to prescind of some extra parts, such as additional connecting parts on the upending device 1 itself or any additional tool e.g. a rigging tool when upending the pile.

Various modifications to the above described embodiments may be possible. For example, the structure of the base element may differ from that described above. For example, the intermediate ring 202 may be replaced by straight plates extending between webs that connect the outer ring 201 and inner ring 203. Indeed such an arrangement is shown in FIGS. 7 and 10. Alternatively, the base element may not comprise concentric rings but may instead be formed of a plurality of arms which have connection elements at radially outer ends, and which are rotationally coupled, about the first axis A1, to the lifting arm 30. The arms of the base element may be semi-circular in shape, such that the connection elements extend along a part of the radially inside surface of the pile in the circumferential direction.

It will be appreciated that the embodiment described with reference to FIGS. 21-23, notably the hoisting element controller and lifting arm, may be used in other configurations of upending device, for example with base elements which are not rotatable, relative to the lifting arm, about the first axis.

It will also be appreciated by those skilled in the art that any number of combinations of the aforementioned features and/or those shown in the appended drawings provide clear advantages over the prior art and are therefore within the scope of the invention described herein.

1. An upending device for upending tubular piles, the upending device comprising;
a base element for insertion into an end of, and for extending along an inside of, the tubular pile;
a plurality of connection elements connected to the base element and configured to engage with one or more inside surfaces of the tubular pile; and
a lifting arm for coupling the upending device to a hoisting element;
wherein the lifting arm is rotatably coupled to the base element, the lifting arm being rotatable relative to the base element about a first axis, wherein the first axis is a central axis of the base element and is substantially parallel to a central axis of the tubular pile, in use.

2. The upending device of claim 1, comprising a mounting element, wherein the lifting arm is rotatably coupled to the base element via the mounting element, wherein the mounting element is rotatably coupled to the base element, the mounting element being rotatable relative to the base element about the first axis.

3. The upending device of claim 1 or 2, wherein the lifting arm is rotatable relative to the base element about a second axis, wherein the second axis is substantially perpendicular to the first axis.

4. The upending device of claim 3, wherein the lifting arm is rotatably coupled to the mounting element, wherein the lifting arm is rotatable relative to the mounting element about the second axis.

5. The upending device of either of claim 3 or 4, comprising a lifting arm driving device for rotation of the lifting arm about the second axis, relative to the base element.

6. The upending device of claim 5, wherein the lifting arm driving device is a linear actuator, wherein the linear actuator is pivotally connected, at a first end, to the lifting arm at a position spaced from the second axis, and is pivotally connected, at a second end, to the mounting element.

7. The upending device of any of claims 3 to 6, comprising driving means located between the mounting element and the base element, for controlling rotational movement, about the first axis, of the base element relative to the mounting element.

8. The upending device of claim 7, wherein the driving means comprises a pinion and a gear, wherein the gear is rotatably mounted to the mounting element and the pinion is provided in the base element.

9. The upending device of any preceding claim, wherein each connection element comprises:
an engagement part, the engagement part comprising a coupling portion, wherein the coupling portion has a coupling surface facing radially inwardly; and
a connection part, the connection part comprising:
a radially outer portion, wherein the radially outer portion has a coupling surface facing radially outwardly, wherein the coupling surface of the engagement part abuts the coupling surface of the radially outer portion of the connection part, and wherein each connection part and corresponding engagement part are moveable in the radial direction; and
first connection means at the radially outer end of each connection part, the first connection means for connection to axial locking means, the axial locking means being for connection between the connection part and the engagement part, for restricting axial movement of the engagement part relative to the connection part,
and wherein the base element comprises second connection means for connection to actuation means connectable between the base element and the engagement part, for moving the engagement part along the coupling surface of the connection part.

10. The upending device of claim 9, wherein the coupling portion of the engagement part is a tapered portion, wherein the radial thickness of the tapered portion is tapered away from the side of the base element on which the lifting arm is located, and wherein the radial thickness of the radially outer portion of the connection part is tapered towards the side of the base element on which the lifting arm is located.

11. The upending device of either of claim 9 or 10, wherein each connection element comprises a further connection part parallel to the connection part and wherein each engagement part comprises a further coupling surface, wherein the further coupling surface of each engagement part abuts the coupling surface of the further connection part.

12. The upending device of any of claims 9 to 11, comprising a drive shaft located between a radially inner end of each connection part and the base element, each drive shaft being configured to translate the respective connection part in the radial direction.

13. The upending device of any preceding claim, comprising at least one guiding element attached to the base element, for contacting a radially inner surface of the tubular pile to control the radial position of the base element with respect to the tubular pile, in use.

14. The upending device of claim 13, wherein the at least one guiding element comprises at least two centralisers, each centraliser being radially slidably connected to the base element, located on a respective radial half of the base element, and extendable from a radially outer surface of the base element.

15. A method of upending a tubular pile, the method comprising the following steps:
a) inserting a base element into a first end of the tubular pile;
b) rotating the base element about a first axis, the first axis being a central axis of the base element and being substantially parallel to a central axis of the tubular pile, to a desired orientation with respect to the tubular element;
c) radially outwardly moving an engagement part of each of a plurality of connection elements to engage with one or more inside surfaces of the tubular pile;
d) lifting the first end of the tubular pile by hoisting a lifting arm, using a hoisting element connected to the lifting arm, the lifting arm being connected to the base element.

16. The method according to claim 15, further comprising step a1), wherein step a1) precedes step a), step a1) comprising lowering the base element, the plurality of connection elements and the lifting arm into a position adjacent the first end of the tubular pile, and rotating the base element and the plurality of connection elements relative to the lifting arm about a second axis, the second axis being perpendicular to the first axis, to substantially align the first axis and the central axis of the tubular pile.

17. The method of either of claim 15 or 16, wherein step d) comprises rotating the lifting arm, relative to the base element and the plurality of connection elements, about the or a second axis, the second axis being perpendicular to the first axis, while the first end of the tubular pile is suspended by the upending device.

18. A method of deploying a tubular pile, the method comprising a method of upending the tubular pile according to any of claims 15 to 17, the method comprising the subsequent step of rotating the base element, the plurality of connection elements and the tubular pile about the first axis to adjust the heading of the tubular pile.

19. An upending device for upending tubular piles, the upending device comprising:
a base element for insertion into an end of, and for extending along an inside of, the tubular pile;
a lifting arm connected to the base element, the lifting element being for coupling the upending device to a hoisting element;
a plurality of connection elements connected to the base element and configured to engage with one or more inside surfaces of the tubular pile, wherein each connection element comprises:
an engagement part, the engagement part comprising a coupling portion,
wherein the coupling portion has a coupling surface facing radially inwardly; and
a connection part, the connection part comprising:
a radially outer portion, wherein the coupling surface of the engagement part abuts the coupling surface of the radially outer portion of the connection part, and wherein each connection part and corresponding engagement part are moveable in the radial direction; and
first connection means at the radially outer end of each connection part, the first connection means for connection to axial locking means, the axial locking means being for connection between the connection part and the engagement part, for restricting axial movement of the engagement part relative to the connection part,
and wherein the base element comprises second connection means for connection to actuation means connectable between the base element and the engagement part, for moving the engagement part along the coupling surface of the connection part.

20. The upending device of claim 19, wherein the coupling portion of the engagement part is a tapered portion, wherein the radial thickness of the tapered portion is tapered away from the side of the base element on which the lifting arm is located, and wherein the radial thickness of the radially outer portion of the connection part is tapered towards the side of the base element on which the lifting arm is located.

21. The upending device of either of claim 19 or 20, wherein the at least one connection part comprises two, parallel, connection parts, and wherein each engagement part comprises first and second coupling surfaces, which each abut a coupling surface of the radially outer end of a respective one of the corresponding connection parts.

22. The upending device of any of claims 19 to 21, comprising a drive shaft located between a radially inner end of each connection part and the base element, each drive shaft being configured to move the respective connection part and engagement part in a radial direction.

23. The upending device of any of claims 19 to 22, wherein the lifting arm is rotatably coupled to the base element, the lifting arm being rotatable relative to the base element about a first axis, wherein the first axis is a central axis of the base element and is substantially parallel to a central axis of the tubular pile, in use.

24. The upending device of claim 23, comprising a mounting element, wherein the lifting arm is rotatably coupled to the base element via the mounting element, wherein the mounting element is rotatably coupled to the base element, the mounting element being rotatable relative to the base element about the first axis.

25. The upending device of either of claim 24, wherein the lifting arm is rotatable relative to the base element about a second axis, wherein the second axis is substantially perpendicular to the first axis.

26. The upending device of claim 25, wherein the lifting arm is rotatably coupled to the mounting element, wherein the lifting arm is rotatable relative to the mounting element about the second axis.

27. The upending device of either of claim 25 or 26, comprising a lifting arm driving device for rotation of the lifting arm, about the second axis, with respect to the base element.

28. The upending device of claim 27, wherein the lifting arm driving device is a linear actuator, wherein the linear actuator is pivotally connected, at a first end, to the lifting arm at a position spaced from the second axis, and is pivotally connected, at a second end, to the mounting element.

29. The upending device of any of claims 23 to 28, comprising driving means located between the mounting element and the base element, for controlling rotational movement, about the first axis, of the base element relative to the lifting arm.

30. The upending device of claim 29, wherein the driving means comprises a pinion and a gear, wherein the gear is rotatably mounted to the mounting element and the pinion is provided in the base element, or wherein the gear is rotatably mounted to the base element and the pinion is provided in the mounting element.

31. An upending system for upending tubular piles, the upending system comprising:
the upending device of any of claims 12 to 14 or 19 to 30;
the axial locking means; and
the actuation means;
wherein each connection element has a frictional lifting configuration and a flange lifting configuration.

32. An upending system according to claim 31, wherein in the frictional lifting configuration, the engagement parts are connected to the actuation means and the actuation means are connected to the connection means of the base element.

33. An upending device according to either claim 31 or 32, wherein in the flange lifting configuration, the engagement parts are connected to the axial locking means and the axial locking means are connected to the respective at least one connection part.

34. An upending device according to any of claims 31 to 33, wherein each connection element comprises:
the or an engagement part;
at least one strip of teeth which is attachable to a radially outer surface of the respective engagement part;
wherein in the frictional lifting configuration the at least one strip of teeth is attached to the radially outer surface of the engagement part.

35. An upending device according to any of claims 31 to 34, wherein each connection element comprises:
the or an engagement part;
at least one axial rail which is attachable to an axial surface of the respective engagement part, proximal the radially outer surface of the respective engagement part, the axial surface facing the lifting arm, in use;
wherein in the flange lifting configuration the at least one axial rail is attached to the engagement part.

36. An upending system according to claim 35, wherein each connection element comprises at least one radial rail which is attachable to the radially outer surface of the respective engagement part and wherein, in the flange lifting configuration at least one radial rail is attached to each engagement part.

37. An upending system according to either of claim 35 or 36, wherein in the flange lifting configuration, the engagement parts are connected to the axial locking means and the axial locking means are connected to the respective at least one connection part.

38. A method of upending a tubular pile using the upending system according to any of claims 31 to 37, the method comprising the following steps:
a) connecting each one of the plurality of engagement parts to a respective one or more connection part to form the respective connection element;
b) inserting the base element into a first end of the tubular pile;
c) radially outwardly moving the plurality of connection elements to engage with one or more inside surfaces of the tubular pile;
d) lifting the first end of the tubular pile by hoisting a lifting arm, using a hoisting element connected to the lifting arm, the lifting arm being connected to the base element.

39. A method according to claim 38 when dependent upon any of claims 31 to 37, wherein step a) comprises configuring the connection elements into either the frictional lifting configuration or the flange lifting configuration.

40. A method according to claim 39, wherein configuring the connection elements into the frictional lifting configuration comprises detaching any radial and/or axial rails which are attached to engagement parts, and attaching at least one strip of teeth to each engagement part, and wherein configuring the connection elements into the flange lifting configuration comprises detaching any strips of teeth which are attached to engagement parts, and attaching at least one axial rail to each engagement part.
